(19) United States
(12) Patent Application Publication
(10) Pub. No.: US 2017/0209004 A1
(43) Pub. Date: Jul. 27, 2017

(54) Bathtub Water Capturing Assembly

(71) Applicant: Shea Jackson, Castalian Springs, TN (US)

(72) Inventor: Shea Jackson, Castalian Springs, TN (US)

(21) Appl. No.: 15/007,537

(22) Filed: Jan. 27, 2016

(51) Int. Cl. A47K 3/00; F16B 47/00; A47K 3/30

(52) U.S. Cl. CPC A47K 3/001; A47K 3/302; F16B 47/00

(57) ABSTRACT

A bathtub water capturing assembly includes a mount with a top wall having a front edge, a rear edge, a first end edge and a second end edge. A front wall is attached to and extends downwardly from the front edge. A rear wall is attached to and extends downwardly from the rear edge. A receiving space is defined between the front and rear walls. The receiving space receives the bathtub wall. A housing for catching water is attached to the front wall. The housing has an open top side.

### BACKGROUND OF THE DISCLOSURE

### Field of the Disclosure

The disclosure relates to bathtub water catch devices and more particularly pertains to a new bathtub water catch device for capturing water which flows over a wall of a bathtub.

### SUMMARY OF THE DISCLOSURE

An embodiment of the disclosure meets the needs presented above by generally comprising a mount including a top wall having a front edge, a rear edge, a first end edge and a second end edge. A front wall is attached to and extends downwardly from the front edge. A rear wall is attached to and extends downwardly from the rear edge. A receiving space is defined between the front and rear walls. The receiving space receives the bathtub wall. A housing for catching water is attached to the front wall. The housing has an open top side.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a broken, top perspective view of a bathtub water capturing assembly according to an embodiment of the disclosure.

FIG. 2 is a side view of an embodiment of the disclosure.

FIG. 3 is a perspective in-use view of an embodiment of the disclosure.

FIG. 4 is a cross-sectional view of an embodiment of the disclosure taken along line 4-4 of FIG. 3.

FIG. 5 is a cross-sectional view of an embodiment of the disclosure taken along line 5-5 of FIG. 2.

### DESCRIPTION OF THE PREFERRED EMBODIMENT

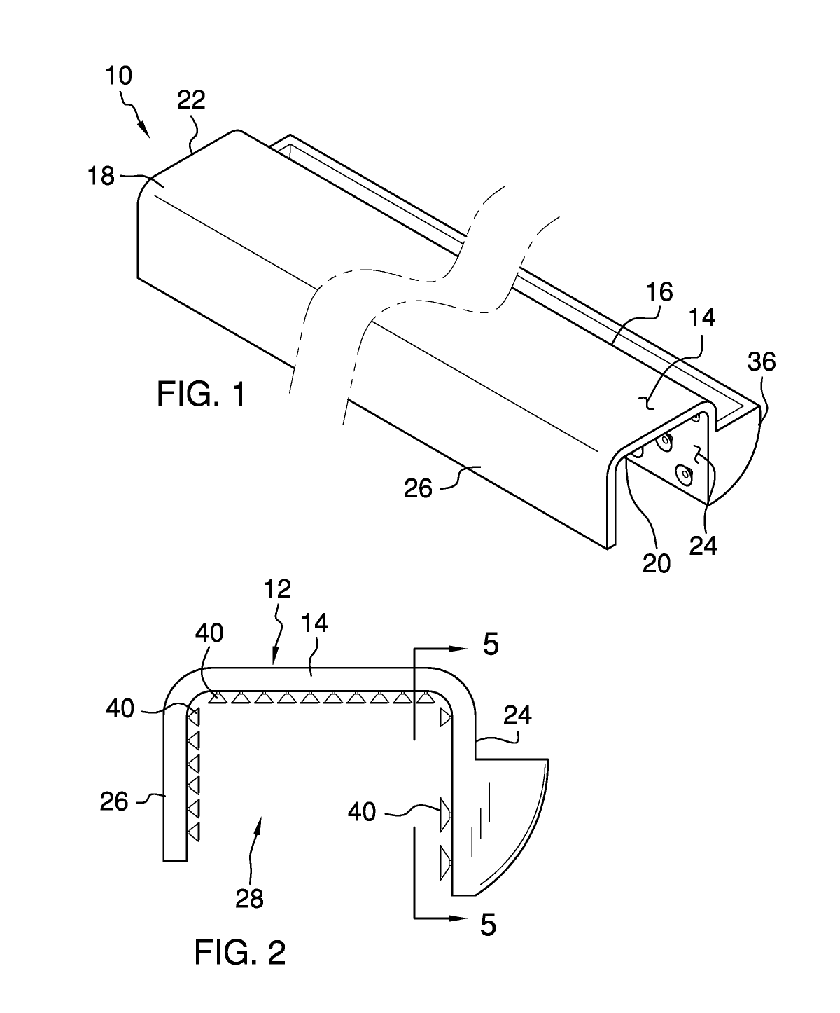

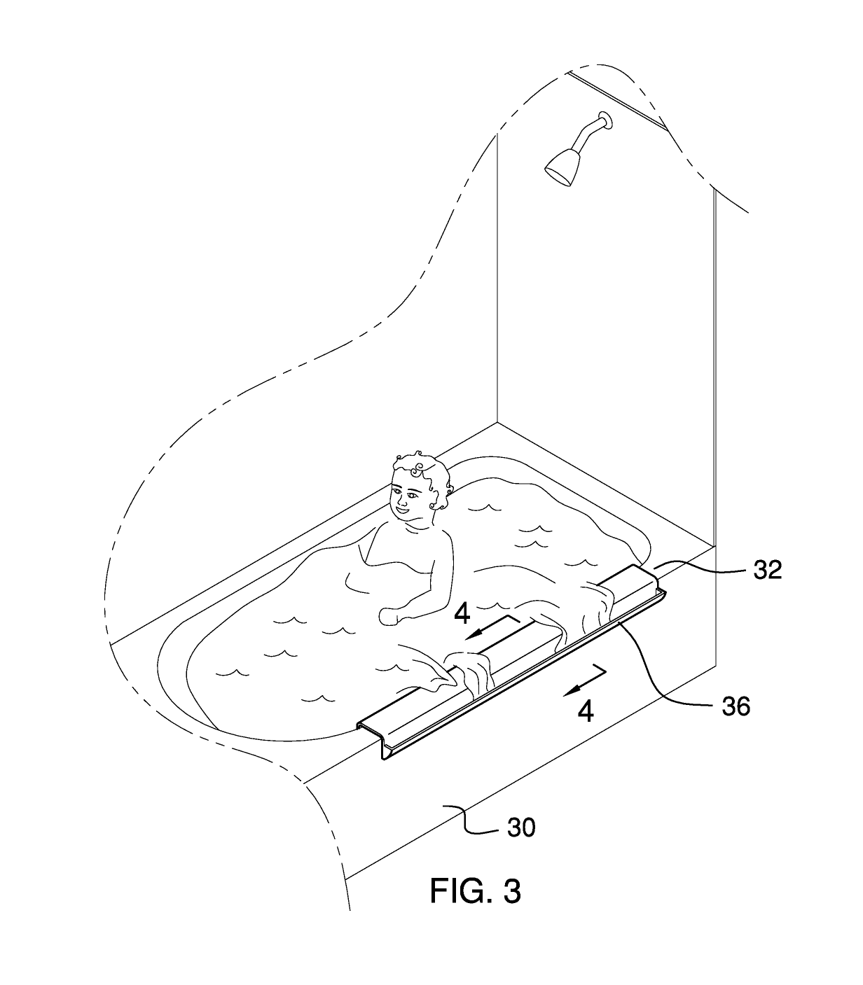

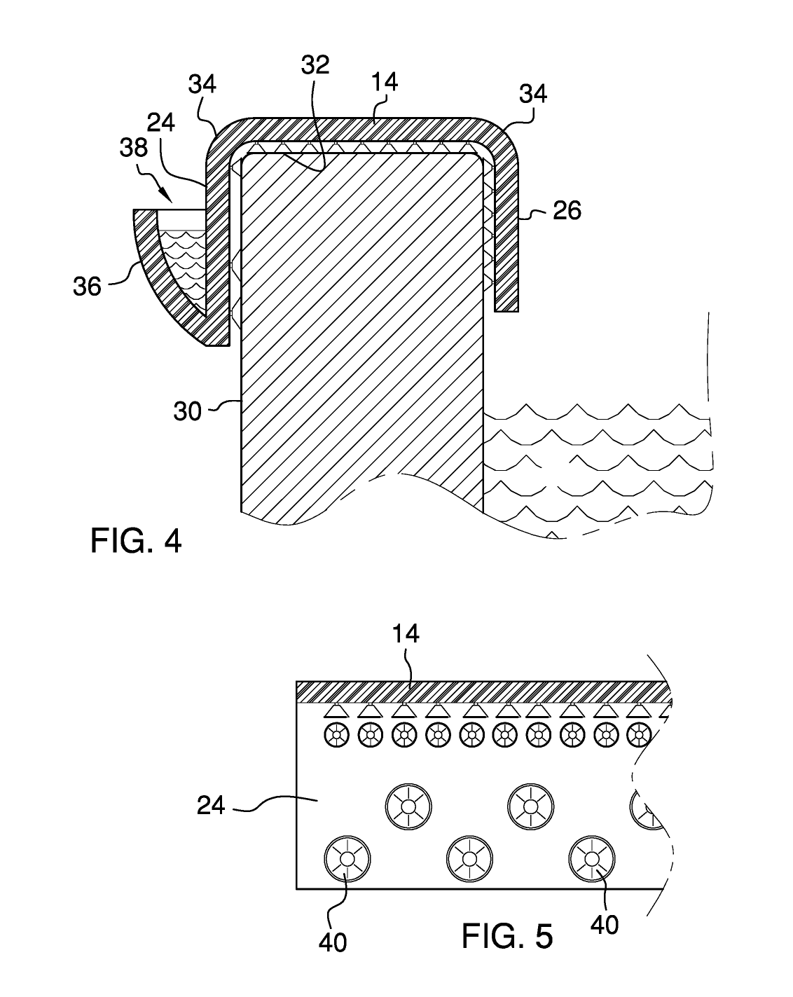

With reference now to the drawings, and in particular to FIGS. 1 through 5 thereof, a new bathtub water catch device embodying the principles and concepts of an embodiment of the disclosure and generally designated by the reference numeral 10 will be described.

As best illustrated in FIGS. 1 through 5, the bathtub water capturing assembly 10 generally comprises a mount 12 that includes a top wall 14 having a front edge 16, a rear edge 18, a first end edge 20 and a second end edge 22. A front wall 24 is attached to and extends downwardly from the front edge 16. A rear wall 26 is attached to and extends downwardly from the rear edge 18. A receiving space 28 is defined between the front 24 and rear 26 walls. The receiving space 28 is configured to receive a bathtub wall 30 such that the top wall 14 is positioned over an upper edge 32 of the bathtub wall 30. Each of the front 24 and rear 26 walls is coextensive with the top wall 14. The top wall 14 has a length from the first end edge 20 to the second end edge 22 that is between 30.0 inches and 42.0 inches. The front 24 and rear 26 walls each have a height between 3.0 inches and 7.0 inches. The mount 12 is comprised of a resiliently compressible material such as an elastomeric material. Junctures 34 of the top wall 14 with the front 24 and rear 26 walls are both arcuate. The arcuate junctures 34 and the compressibility of the material prevent injuries to a person who might fall onto the mount 12 while also protecting the person from the bathtub wall 30.

A housing 36 configured for catching water is attached to the front wall 24. The housing 36 has an open top side 38 for receiving water spilled over the bathtub wall 30. The housing 36 extends at least 80% of a length of the front wall 24. As shown in the Figures, the housing 36 may be coextensive with the front wall 24.

A plurality of suction cups 40 is attached to the mount 12 and positioned within the receiving space 28. The suction cups 40 are configured to be releasably attached to the bathtub wall 30. The suction cups 40 may be placed on the front wall 24, rear wall 26 and top wall 14.

In use, the assembly 10 is placed on the wall 30 of a bathtub as shown in the Figures. The assembly 10 will catch water which flows over the bathtub wall 30. Further, the assembly 10 protects a person from injuring themselves on the bathtub wall 30 as well as prevents injuries which may be caused by water flowing onto a floor and making such slippery. Additionally, by preventing water from spilling outwardly of the bathtub, damage to flooring and woodwork will be prevented.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A bathtub trough and edge protector assembly configured for positioning on an upper edge of a bathtub wall, said assembly comprising:
a mount including a top wall having a front edge, a rear edge, a first end edge and a second end edge, a front wall being attached to and extending downwardly from said front edge, a rear wall being attached to and extending downwardly from said rear edge, a receiving space being defined between said front and rear walls, said receiving space being configured to receive said bathtub wall, wherein each of said front and rear walls are coextensive with said top wall;
a housing configured for catching water being attached to said front wall, said housing having an open top side; and
a plurality of suction cups being attached to said mount and positioned within said receiving space along each of said front wall, said rear wall, and said top wall, said suction cups being configured to be releasably attached to the bathtub wall.

2. (canceled)

3. The bathtub trough and edge protector assembly according to claim 1, wherein said top wall has a length from said first end edge to said second end edge being between 30.0 inches and 42.0 inches, each of said front and rear walls having a height between 3.0 inches and 7.0 inches.

4. The bathtub trough and edge protector assembly according to claim 1, wherein said mount is comprised of a resiliently compressible material.

5. (canceled)

6. (canceled)

7. A bathtub trough and edge protector assembly configured for positioning on an upper edge of a bathtub wall, said assembly comprising:
a mount including a top wall having a front edge, a rear edge, a first end edge and a second end edge, a front wall being attached to and extending downwardly from said front edge, a rear wall being attached to and extending downwardly from said rear edge, a receiving space being defined between said front and rear walls, said receiving space being configured to receive said bathtub wall, each of said front and rear walls being coextensive with said top wall, said top wall having a length from said first end edge to said second end edge being between 30.0 inches and 42.0 inches, each of said front and rear walls having a height between 3.0 inches and 7.0 inches, said mount being comprised of a resiliently compressible material;
a housing configured for catching water being attached to said front wall, said housing having an open top side; and
a plurality of suction cups being attached to said mount and positioned within said receiving space along each of said front wall, said rear wall, and said top wall, said suction cups being configured to be releasably attached to the bathtub wall.
